(19) United States
(12) Patent Application Publication
(10) Pub. No.: US 2022/0253777 A1
(43) Pub. Date: Aug. 11, 2022

(54) Dynamically Influencing Interactions Based On Learned Data And On An Adaptive Quantitative Indicator

(71) Applicant: Birdeye, Inc., Palo Alto, CA (US)

(72) Inventors: Neeraj Gupta, Sunnyvale, CA (US); Nathanael William Chambers, Annapolis, MD (US); Ameya Dileep Virkar, Sunnyvale, CA (US)

(21) Appl. No.: 17/665,718

(22) Filed: Feb. 7, 2022

Related U.S. Application Data
(60) Provisional application No. 63/146,883, filed on Feb. 8, 2021.

(51) Int. Cl. G06Q 10/06; G06F 40/40; G06Q 30/02

(52) U.S. Cl. CPC G06Q 10/06315; G06Q 30/0282; G06Q 30/0203; G06F 40/40

(57) ABSTRACT

Techniques are disclosed for generating and dynamically updating an experience score for a client, where the experience score operates as a quantitative indicator describing a relationship between the client and an entity. The experience score is used to modify subsequent interactions the client has with the entity. Sentiment data detailing the relationship between the client and the entity is acquired. The sentiment data is received from different types of interactions the client had relative to the entity. NLP is used to provide structure to the sentiment data, resulting in an initial set of scoring data being made available. That scoring data is normalized. After normalizing the scoring data, weighting factors are applied to the scoring data to generate weighted scores. The experience score is then generated by aggregating the weighted scores. The experience score is used to then modify a subsequent interaction the client has with the entity.

### CROSS-REFERENCE TO RELATED APPLICATIONS

This application claims the benefit of and priority to U.S. Provisional Patent Application Ser. No. 63/146,883 filed on Feb. 8, 2021 and entitled “Customer Experience Score,” which application is expressly incorporated herein by reference in its entirety.

### BACKGROUND

Businesses have many touch points with their customers, but individual moments of interaction from a customer do not accurately capture that customer's overall experience and feelings toward the business. The business may draw incorrect conclusions about the approval of their products or services based on old feedback or incomplete feedback that does not capture the entire, real-time experience of a customer. Businesses do not know which customers are unhappy, which are satisfied, and which could be potential ambassadors for their products or services, when the businesses consider only the individual moments of customer interaction.

Businesses may use the services of third-party service providers to help track, analyze, and leverage the interactions with their customers. These third-party providers are often referred to as reputation management companies, marketing technology companies, marketing software companies, or other specialized service providers (hereinafter these third parties shall be referred to as “martech” companies).

Businesses rely on martech companies' services because they are adept at such things as obtaining, aggregating, and analyzing online reviews or sending out and analyzing appropriate surveys and customers' responses to survey questions. From these traditional direct interactions with customers, martech companies had limited data points to create a historical and very narrow view of a customer's happiness with a company or its products or services, particularly as they pertained only to a single transaction. These measures of happiness, however, are very myopic and do not cover the customer's overall feelings towards a business entity. What is needed, therefore, is a way to more accurately capture a customer's experiences and to reflect the customer's holistic state towards the business.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein relate to systems, devices, and methods for generating and dynamically updating an experience score for a client, where the experience score operates as a quantitative indicator describing a relationship between the client and an entity. The embodiments are further configured to use the experience score to modify one or more subsequent interactions the client has with the entity so as to improve the relationship.

Some embodiments acquire sentiment data detailing the relationship between the client and the entity. The sentiment data is acquired from different types of interactions the client had relative to the entity, and the sentiment data includes structured sentiment data and unstructured sentiment data. The embodiments use natural language processing (NLP) to provide structure to the unstructured sentiment data. As a consequence, a second set of structured sentiment data is acquired. The combination of the structured sentiment data and the second set of structured sentiment data constitute an initial set of scoring data. The initial set of scoring data is then normalized. For each of the different types of interactions the client had relative to the entity, the embodiments generate a corresponding weighting factor. Each weighting factor assigns a relative importance level to each respective type of interaction. After normalizing the initial set of scoring data, the weighting factors are applied to the initial set of scoring data (i.e. the normalized data) to generate a set of weighted scores. After generating the set of weighted scores, the experience score is generated by aggregating the set of weighted scores. The embodiments then use the experience score to modify a subsequent interaction the client has with the entity.

Some embodiments use an interactions engine to acquire data (which includes sentiment data or which includes data from which sentiment data can be extracted) detailing the relationship between the client and the entity. The interactions engine acquires the sentiment data from different types of interactions the client had relative to the entity. The sentiment data is structured by a machine learning (ML) engine to generate an initial set of scoring data. The initial set of scoring data is then normalized. For each of the different types of interactions the client had relative to the entity, the ML engine generates a corresponding weighting factor, where each weighting factor assigns a relative importance level to each respective type of interaction. After normalizing the initial set of scoring data, the weighting factors are applied to the initial set of scoring data (i.e. the normalized data) to generate a set of weighted scores. After generating the set of weighted scores, the experience score is generated by aggregating the set of weighted scores. The embodiments then use the experience score to modify a subsequent interaction the client has with the entity. In response to the interactions engine acquiring new sentiment data, the ML engine updates the client's experience score.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example architecture that may be used to dynamically generate and update an experience score.

FIG. 2 illustrates some example sources where sentiment data can be acquired.

FIG. 3 illustrates how sentiment data can have different formats, including a structured format and an unstructured format.

FIG. 4 illustrates an example process flow that can be performed by a machine learning engine.

FIG. 5 illustrates how different weights can be applied to scores and how those scores can then be aggregated.

FIG. 6 illustrates an example regression analysis in which the systems attempt to identify which leading factors contributed most to a client's current score.

FIG. 7 illustrates examples of different ways in which a client's experience can be modified in order to improve the client's experience score.

FIG. 8 illustrates an example client interface showing how a client's score can be displayed.

FIG. 9 illustrates another example client interface showing the experience score.

FIG. 10 illustrates a flowchart of an example method for generating, updating, and using an experience score to improve a client's relationship with an entity.

FIG. 11 illustrates another flowchart of an example method for generating and using an experience score.

FIG. 12 illustrates an example computer system configured to perform any of the disclosed operations.

### DETAILED DESCRIPTION

Embodiments disclosed herein relate to systems, devices, and methods for generating and dynamically updating an experience score for a client, where the experience score operates as a quantitative indicator describing a relationship between the client and an entity. The embodiments are further configured to use the experience score to modify one or more subsequent interactions the client has with the entity so as to improve the relationship. A client can be any end user, and an entity can be any business.

In some embodiments, sentiment data detailing the relationship between the client and the entity is acquired. As used herein, “sentiment data” refers to any type of data describing attributes, qualities, events, or interactions a client may have expressed with regard to an entity, where that sentiment data was generated by the client and not necessarily by a biased party. In some cases, sentiment data can be extracted from other types of data. As an example, sentiment data can be extracted (e.g., in an indirect manner) based on an event where a client decided to purchase a product or based on an event where the client decided to not purchase a product. Sentiment data can also be provided in a direct manner, such as in the form of a feedback review.

The sentiment data is received from different types of interactions the client had relative to the entity. NLP is used to provide structure to the sentiment data (e.g., in language form), resulting in an initial set of scoring data being made available. The initial set of scoring data is normalized. After normalizing the initial set of scoring data, weighting factors are applied to the initial set of scoring data to generate weighted scores. After generating the weighted scores, the experience score is generated by aggregating the weighted scores. The experience score is used to then modify a subsequent interaction the client has with the entity.

In some embodiments, an interactions engine acquires sentiment data from different sources and/or different types of interactions the client had relative to the entity. The data is then normalized and weighted by a machine learning (ML) engine. After generating weighted scores, the experience score is generated by aggregating the set of weighted scores. The experience score is used to modify a subsequent interaction the client has with the entity. In response to the interactions engine acquiring new sentiment data, the ML engine updates the client's experience score.

In this sense, the disclosed embodiments generally include the real-time analysis of an individual's direct and indirect interactions with an entity. Such interactions can be online or offline. Using information gleaned from those interactions, the embodiments are able to derive a real-time score regarding the individual's positive, neutral, or negative experience with the entity and its products and services.

### Examples of Technical Benefits, Improvements, and Practical Applications

The following section outlines some example improvements and practical applications provided by the disclosed embodiments. It will be appreciated, however, that these are just examples only and that the embodiments are not limited to only these improvements.

The disclosed embodiments bring about numerous substantial benefits, improvements, and practical applications to the technical field of big data mining and data analysis as well as to other technical fields. As one example, the embodiments are able to use an interactions engine to acquire data detailing how a client interacts with an entity (e.g., perhaps an online entity) or perhaps with a brick and mortar entity. The interactions engine can also acquire data from third-party sources where the client communicated about the entity. For instance, the interactions engine can crawl a public network (e.g., the Internet) to identify instances where a client has provided feedback or comments about an entity and to acquire at least some sentiment data. That feedback can be provided at the entity's own domain and/or it can be provided to third-party sources, such as perhaps a social media platform. Regardless of where this data is located, a machine learning engine is able to identify and then extract that data. In this regard, the interactions engine and the machine learning engine can be configured to perform big data mining and targeted analysis in an effort to find relevant information about a client's relationship with an entity and to acquire at least some sentiment data.

From that acquired data, the embodiments can then beneficially derive, infer, or deduce a status or state of the relationship between the client and the entity. This status can be quantified in the form of a so-called “experience score” (or simply “score”). Generally, a higher score illustrates a better relationship between the client and the entity while a lower score illustrates a worse relationship. By examining this score, entities are greatly benefitted because they can then determine which clients will likely be advocates and which clients will likely be detractors. Additionally, the entities can then try to rehabilitate relationships by performing various actions, as will be discussed in more detail to follow. In this regard, the embodiments are configured to improve client-entity relationships.

The described experience score can also be used to modify subsequent interactions the client might have with the entity. As an example, the score can be used to prevent the display of certain information that was determined to be unfit or offensive for a particular client. As another example, the score can be used to trigger the display of certain information that is of particular relevance for a client. The score can also be used to modify modes of communication that are used when the entity communicates with the client. In some cases, modifying subsequent interactions can be performed by modifying the visual layout or even the visual display of information in order to better suite a client. In some instances, the score can also be used to reduce the number of steps that are required for a client to reach a desired endpoint, such as perhaps the display of information about a particular product. The score can also be used to update a system's information about the client in order to ensure that preferences of the client are later implemented when that client interacts with the entity. As yet another example of a beneficial modification in how the system behaves based on the score, the embodiments can also trigger targeted campaigns and/or opportunities for referrals.

From these various examples, one can observe how the behavior of the computer system can be modified based on a client's derived score. Such modifications are designed to improve how the client interacts with the system.

Furthermore, in some cases, such modifications can actually lead to improvements in the functioning of the system itself, such as when the modifications lead to reductions in the number of steps that are followed when a client interacts with the entity (e.g., perhaps by reducing the number of navigations a client performs with respect to a web browser), thereby resulting in improved computing efficiency. That is, fewer steps result in less required computations, thereby improving computing efficiency. In some cases, predictive computing can also be performed in order to preemptively address concerns or issues the client may have. In some cases, actions can be performed (based on the score) in order to entirely avoid scenarios that have been predicted will be troublesome for a client. Accordingly, these and numerous other benefits, improvements, and advantages will be discussed in more detail in the remaining portions of this disclosure.

### Example Architecture For Generating And Using An Experience Score

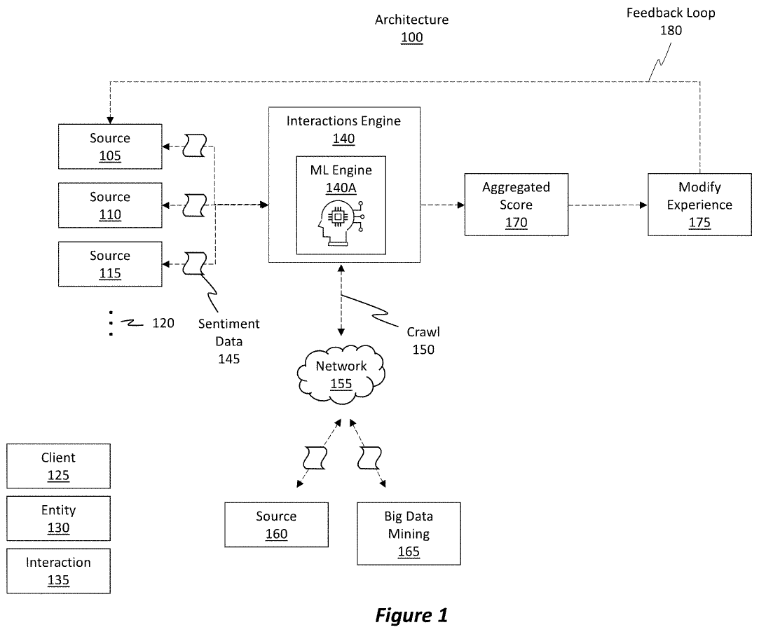

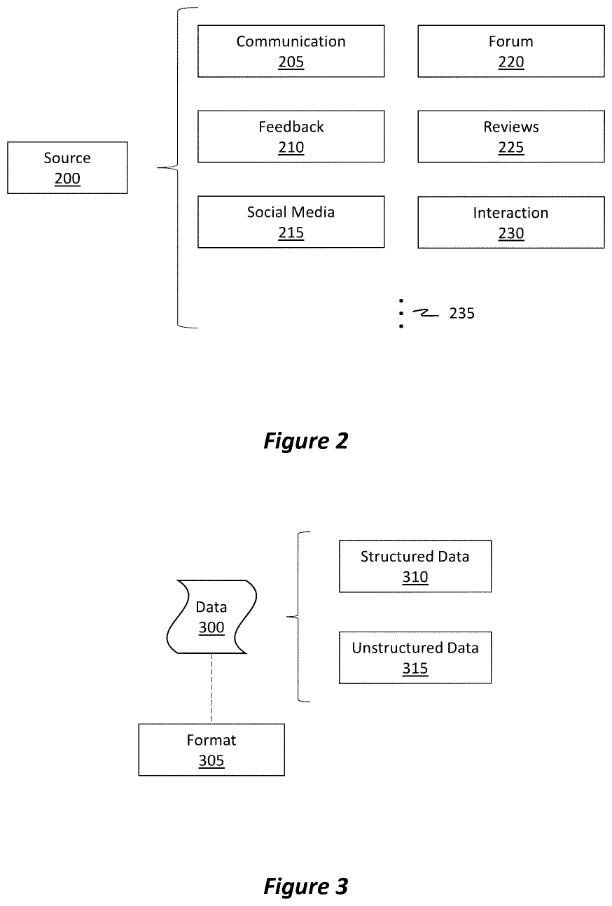

Attention will now be directed to FIG. 1, which illustrates an example architecture 100 in which an experience score can be generated, dynamically updated, and also used to modify an experience or a journey a client has in interacting with an entity, such as perhaps an online entity. Initially, architecture 100 shows a number of sources, such as source 105, source 110, and source 115. The ellipsis 120 demonstrates how other sources can be present as well. These sources represent entities and/or occurrences where the client (e.g., a client 125) interacted with or about a particular entity 130. That is, the displayed sources represent origins where the client 125 had an interaction 135 with or about the entity 130. FIG. 2 provides some helpful illustrates about the different types of sources.

FIG. 2 shows a source 200, which is representative of any of the sources listed in FIG. 1. As one example, the source 200 can be any type of communication 205 where the client is engaged with or about an entity. Such communication 205 can include any type of text message, email message, web chat, phone call, and so forth, without limit. These communications can be recorded or obtained and can be analyzed to identify the client's interactions with or about the entity.

As another example, the source 200 can be any type of feedback 210 that a client provides about an entity. This feedback 210 can be provided directly to the entity, such as in the form of a client review or perhaps a survey. In some instances, the survey is a binary feedback survey in the form of a thumbs up or thumbs down selection, a stars-based feedback survey where the client selects zero to five stars to indicate his or her satisfaction with the entity, or a text-based survey where the client inputs one or more words of feedback into a feedback textbox. This feedback 210 can also be acquired from any third-party organization, such as a Yelp review, Google's business review, Apple App Store review, or Google Play review.

The source 200 can also be any type of social media 215 platform, such as Facebook, Twitter, Instagram, YouTube, TikTok, and so forth. A client might post his/her experience with an entity on social media 215. In such instances, the system is configured to identify and recognize relevant feedback information from text, audio, and/or visual sources. For example, if a client posts a video review, the system is able to extract feedback from verbal cues, visual cues, and/or textual cues from the video content. In some instances, the system is also configured to crawl through one or more comments that a client has made on another person's review, where the system can glean information about whether the client agreed with or disagreed with one or more aspects of the review on which he or she commented.

In some instances, the system is configured to weight certain feedback. For example, if the system gathers sentiment data from various sources, some sources may be ranked/weighted higher than others based on other external data. For example, the system can discover that reviews posted to Google express more reliable sentiment than casual tweets on Twitter, thus weighting Google's reviews higher.

The source 200 can also include information posted to any type of forum 220. As an example, a student forum might be developed to discuss a particular college. That forum 220 can then operate as a source. In another example, the forum may be a Reddit forum, where the system is able to extract information from the formation of a new forum by a client. In such instances, the system is also able to track the forum over time to see if the client's sentiment is changing over time by reviewing the continuation of comments between the client and other Reddit users and/or reviewing the creation of sub-Reddits.

Any type of client reviews 225 can also operate as a source. Additionally, any other type of interaction 230, which would also include the lack of an interaction, can operate as a source. To illustrate, a client might be provided a survey or a promo code. If the client elects to ignore that survey or promo code, this lack of an interaction can represent a source of data for the embodiments to use. Likewise, if the client does elect to respond to the survey or does use the promo code, this affirmative response can also operate as a source of data. The ellipsis 235 illustrates how other sources can also be queried and can be used as a repository of information.

Returning to FIG. 1, an interactions engine 140 is configured to acquire sentiment data 145 from these various sources, including direct sources and indirect sources, where that data reflects the client's interactions with or about the entity. In some instances, a machine learning (ML) engine 140A is configured to learn which sources provide better sentiment data 145 (e.g., relevant sentiment data that contributes to the sentiment score or sentiment data that is more easily processed/normalized), and the ML engine 140A can instruct the interactions engine 140 as to where to acquire sentiment data. The interactions engine 140 can gather sentiment data 145 from certain sources and/or can ignore sentiment data 145 from other sources that do not help the system in generating a sentiment score. In some implementations, manual settings can be applied and/or manipulated to weight sources and/or sentiment data.

As mentioned earlier, “sentiment” data refers to any type of data describing attributes, qualities, events, or interactions a client may have expressed with regard to an entity, where that sentiment data was generated by a client and not necessarily by a biased party (e.g., a manufacturer of the product). This sentiment data may be distributed across any number of sources, such as websites, including a manufacturer's or entity's own website. By way of example, a website may list product reviews of a product, where the product reviews are provided by consumers or purchasers of the product. The embodiments are able to navigate to these product reviews and identify the sentiment data. That is, customer sentiment expressed in direct and indirect interactions with an entity is collected and analyzed. As will be described in more detail later, that data may then be analyzed to determine whether the product reviews reflect positive, negative, or neutral views of the product. Using that sentiment data, the embodiments are then able to generate a score to quantify how the client views the entity.

In an example scenario, an entity can share a list of customers, such as their email/phone numbers, previous surveys, or related customer interactions, with a platform, such as the architecture 100 of FIG. 1. Sharing can be done through direct upload or integration of the entity's customer relationship management (CRM) with the entity's platform/architecture. The entity's platform can monitor all customer interactions in their CRM or on the entity's platform. The platform (e.g., the architecture 100) can be used to email or text message customers with requests regarding their experiences, including but not limited to new survey requests. In addition, the platform can be used to send out referral requests, including asking its customers to refer a friend.

As one example, consider a scenario where a survey was provided to a client, and the client responded to that survey. Here, the interactions engine 140 is able to acquire the survey, the results of the survey, and any other information that may be pertinent to that survey. Working in concert with the interactions engine 140, the ML engine 140A can determine whether the client recently purchased an item from the entity or whether the client recently visited the entity (e.g., perhaps from stored GPS tracking data). As will be discussed in more detail later, the ML engine 140A can analyze that information to then derive or compute an experience score for the client, where the experience score provides a quantified metric detailing how the client views the entity.

In some cases, the sources can be linked to an entity's platform, such as a website that offers clients the opportunities to leave feedback. In other scenarios, the sources are independent relative to the entity, such as the case where the source is in the form of a social media platform or some other independent entity. In such scenarios, the interactions engine 140 can be configured to crawl 150 a public network (e.g., the Internet) to identify other sources (e.g., indirect sources or third party sources) where a user may have expressed his/her viewpoints about a particular entity. For instance, FIG. 1 shows the interactions engine 140 crawling a network 155 to identify a source 160 that is entirely independent of the entity 130 and that can be a third party source. From this source 160, the interactions engine 140 can acquire additional sentiment data. Accordingly, in this sense, the disclosed interactions engine 140 and ML engine 140A can be configured to perform big data mining 165 and analysis.

In some scenarios, such as where a client has enabled microphone access associated with the entity or a separate application that is linked to the entity, the system is able to gather feedback data, through automatic speech recognition, by identifying relevant speech signals recorded by a client's microphone (i.e. if the client is speaking about his or her interaction with the entity).

As used herein, any type of ML engine, algorithm, model, or neural network may be used to perform the disclosed operations. As used herein, reference to “machine learning” or to a ML model or to a “neural network” may include any type of machine learning algorithm or device, neural network (e.g., convolutional neural network(s), multilayer neural network(s), recursive neural network(s), deep neural network(s), dynamic neural network(s), etc.), decision tree model(s) (e.g., decision trees, random forests, and gradient boosted trees), linear regression model(s) or logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

As mentioned above, the embodiments are able to acquire sentiment data from any number of sources. The sentiment data details a relationship between a client and an online entity. Furthermore, the sentiment data is acquired from different types of interactions the user had relative to the online entity. The illustrated “sources” represent avenues by which these interactions occurred. For instance, one type of interaction can be a user's response to a survey, and the “source” would be the survey. Another type of interaction can be a user's comments about the entity in a social media post, and the source would be the social media platform. Another type of interaction can be a user providing feedback in a website, and the source would be the website.

This sentiment data can have different forms, formats, or even structures. FIG. 3 is illustrative.

FIG. 3 shows data 300, which is representative of the sentiment data described in FIG. 1. The data 300 can have different formats, as shown by format 305. For instance, the format 305 can be in the form of text, audio, video, or any other available format. In some instances, the system is configured to recognize one or more predefined keywords that are known to be associated with particular sentiment of the client (i.e. where certain keywords indicate or contribute to a positive or negative sentiment score). Additionally, or alternatively, the system is configured to determine a generalized contextualized understanding from the data 300.

The data 300 can also be in the form of structured data 310 or unstructured data 315. As used herein, structured data 310 refers to data that is stored in a predefined format while unstructured data 315 can be a conglomeration of varied data types that are stored together in their native formats. An example of structured data 310 would be a specific 1-5 star rating for a product. An example of unstructured data 315 would be a user's typewritten comments on the quality of a product. In some instances, the system is configured to convert unstructured data into structured data (e.g., a pre-defined summary template that is populated with the relevant information extracted from the unstructured data).

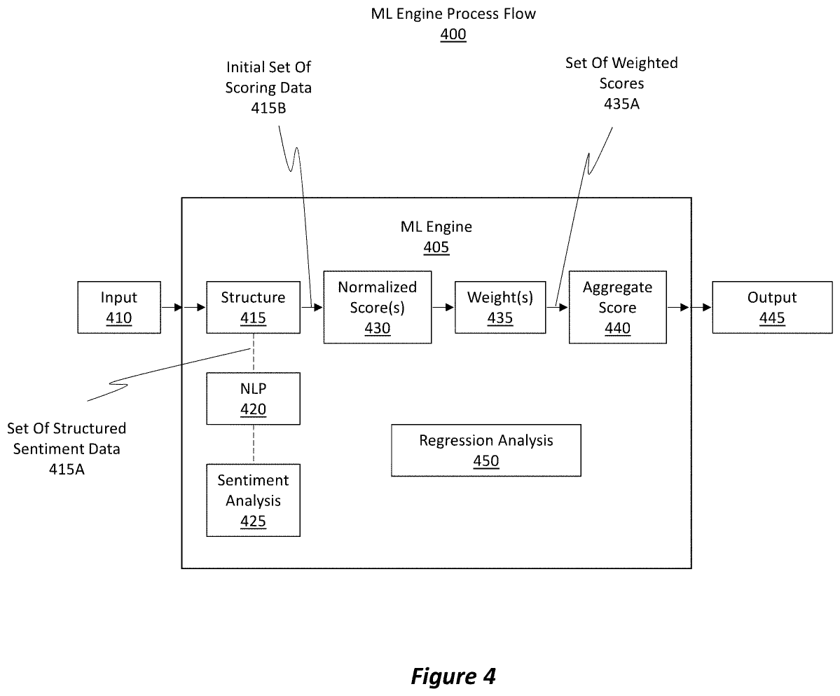

Returning to FIG. 1, the interactions engine 140 is able to acquire both structured data and unstructured data from any number of sources, where the acquired data can be used to describe or infer a client's relationship with an entity and where the acquired data is acquired from different types of interactions the client had relative to the entity. The ML engine 140A is able to analyze, process, and synthesize the acquired data in any number of ways in order to generate an aggregated score 170, which is also referred to herein as an “experience score.” FIG. 4 provides some additional clarification regarding some of the processes that can be performed to generate the aggregated score 170.

FIG. 4 shows an ML engine process flow 400 that can be performed by an ML engine 405. The ML engine 405 is representative of the ML engine 140A from FIG. 1.

The process flow 400 starts by the ML engine 405 acquiring input 410 (e.g., perhaps from the interactions engine mentioned earlier). The input 410 to representative of the sentiment data that was acquired by the interactions engine 140 from FIG. 1. In some cases, the ML engine 405 directs the interactions engine to search and acquire the input 410 while in other cases the ML engine 405 has a hands-off approach on the search, and the input is fed into the ML engine 405, such as by using any number of application programming interfaces (API)s.

In any event, the ML engine 405 receives the input 410 and then begins to operate on it. If the input 410 is or includes unstructured data, then the ML engine 405 can be configured to provide structure 415 to the input 410. For instance, the ML engine 405 can be configured to include a natural language processing engine, as shown by NLP 420. As a result of providing structure to the unstructured data, the ML engine 405 generates a second set of structured sentiment data 415A. The combination of the original structured sentiment data (e.g., structured data 310 from FIG. 3) and the second set of structured sentiment data 415A constitutes an initial set of scoring data 415B.

The NLP 420 is able to review and analyze the input 410 to perform a sentiment analysis 425. To be clear, the NLP 420 is able to review and analyze not only text-based input, but it is also able to review and analyze image data, video data, audio data, and any other type of data (e.g., with language in it).

For instance, the NLP 420 is able to utilize any type of optical character recognition (OCR) to identify and determine text that is recognizable. The NLP 420 is also able to perform word segmentation (often called tokenization) in order to separate bodies of text into different words. The NLP 420 is also able to perform a morphological analysis on text, such as by performing morphological segmentation or even part-of-speech tagging. The NLP 420 is also able to perform syntactic analysis to identify the underlying syntax of words describing an interaction. By way of example, the NLP 420 can perform both dependency parsing (i.e. identifying relationships between words in a sentence) and constituency parsing (i.e. generating a parse tree based on the relationship between the words). The NLP 420 can also perform any type of lexical semantics, distributional semantics, named entity recognition, sentiment analysis, terminology extraction, and word sense disambiguation. Accordingly, the NLP 420 is able to perform any type of natural language processing to identify aspects related to a client's viewpoint regarding a particular entity.

By performing the sentiment analysis 425, the NLP 420 can transform unstructured data into structured data. An example will be helpful.

Suppose a client provided the following review about a business entity: “the customer support was so helpful, and I love their product.” The NLP 420 is able to receive this unstructured data as input and perform sentiment analysis on this data. Here, the NLP 420 will determine that the user has a generally positive disposition toward the business based on the combination of words, particularly the “helpful” term and the “love” term. If a sentiment value were to be provided to this feedback, where the values ranged between 0 and 10, then this input would likely receive a sentiment value of 10. In this manner, a defined “structure” has been provided to the unstructured input. As used herein, the term “structure” refers to organizing or categorizing data in accordance with a predefined format, in this example case the structure is a numerical value ranging from 0 to 10.

As another example, consider a scenario where the client stated the following while streaming in a YouTube video: “this product is ok.” In this example scenario, the NLP 420 may assign the statement a mid-range value, such as perhaps a value of 5 or 6. Here, the client's sentiment is more neutral and does not reflect either positive or negative feelings.

As another example, consider a scenario where the client left the following in an audio voice message to a business representative: “this product is horrible, I hate this business.” In this example scenario, the NLP 420 may assign the comments a low value, such as perhaps a 0 or a 1. Here, the client's sentiment reflects a negative feeling. As yet another example, if a client sets up an appointment with the entity, then this interaction can be considered as a generally positive-producing result, and that interaction can be provided with a sentiment ranking. In another example, if a client returns a product, this may be an indication of a generally negative sentiment, even if the client never posted a review about the product, or if the client makes a repeat purchase of the product, this may be an indication of a generally positive sentiment.

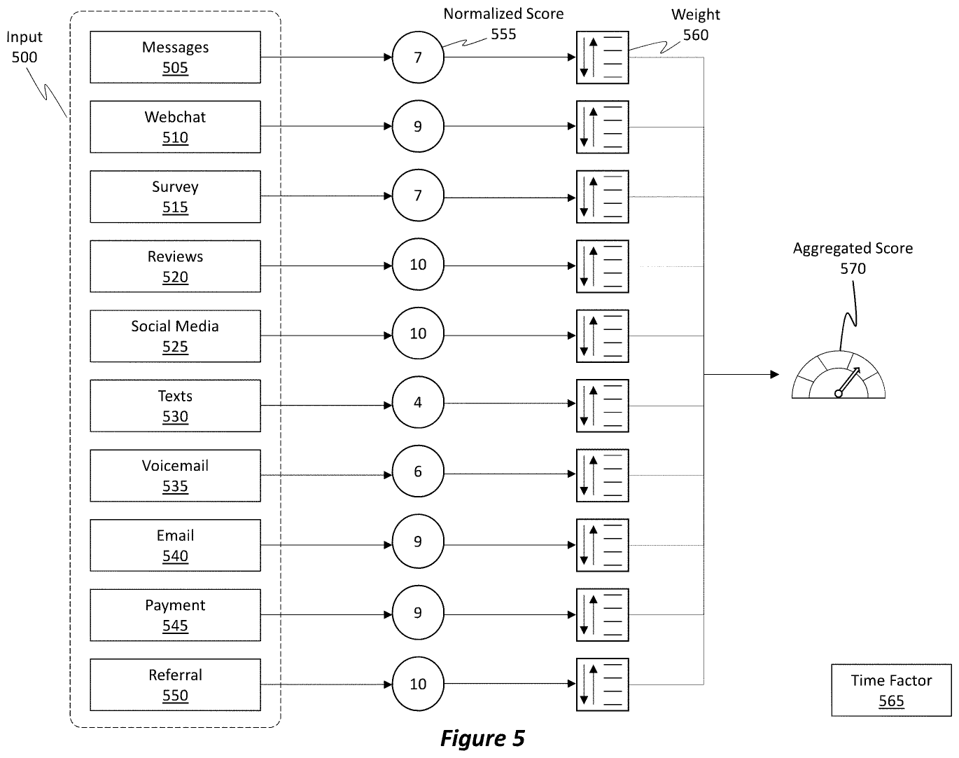

After providing structure to any unstructured data, the ML engine 405 then normalizes the data, all of which should now have the same or matching structure (e.g., perhaps the structure is a numerical indicator), as represented by normalized score(s) 430. As one example, all scores can optionally be normalized to fall within a range between 0 and 10. The process of normalizing the data results in all of the data having the same scale. As an example, consider a scenario where a user can provide a 0-5 star rating for a business. Consider also the scenario where the user's comments were converted to a sentiment value between 0 and 10. If a 0-10 rating system is desired, then the ML engine 405 will normalize the 0-5 star rating structured data by multiplying the values by 2, resulting in a 0-10 rating system. Accordingly, the embodiments are able to normalize any of the originally structured data as well as any of the subsequently structured but originally unstructured data. FIG. 5 provides a useful illustration.

FIG. 5 shows a set of input 500, which is representative of the input 410 from FIG. 4. The input 500 can include data from any number of sources and can include expressions made by a client. As some examples, the input 500 can be acquired from messages 505, a webchat 510, a survey 515, reviews 520, social media 525, texts 530, voicemail 535, email 540, the completion or failure to make a payment 545, and also whether the client referred the entity to another individual, as shown by referral 550. The lack of an interaction can also be provided as a form of input 500.

The ML engine is able to receive the input 500, provide structure to that input 500, and then normalize the input 500. For instance, FIG. 5 shows a normalized score 555 for the messages 505 input, where this normalized score 555 is a value of “7,” normalized on a scale ranging from 0 to 10. Other normalized scores are generated for the other inputs, such as values that include 9, 10, 4, and 6.

Returning to FIG. 4, the process flow 400 includes the ML engine 405 generating and applying weight(s) 435 to each respective input type. That is, the ML engine generates the weighting factors. Optionally, the ML engine can continuously or periodically update the weighting factors over time based on newly learned data, such as newly acquired sentiment data. The weights can also be set manually or perhaps refined. As a result of applying the weights, the ML engine 405 has generated a set of weighted scores 435A. FIG. 5 provides a useful illustration.

For the messages 505 input type, the ML engine is able to generate a first weight. For the webchat 510 input type, the ML engine is able to generate a second weight. For the survey 515 input type, the ML engine is able to generate a third weight. In this fashion, the ML engine is able to generate a different weight for each input type. Stated differently, the ML engine is able to generate a corresponding weighting factor for each of the different types of interactions the client had relative to the entity. Each weighting factor assigns a relative importance level to each respective type of interaction.

In the scenario shown in FIG. 5, the ML engine assigned a weight 560 to the normalized score 555. Other weights were assigned to the other normalized scores. The ML engine is able to weight or prioritize some types of interactions over other types of interactions. As an example, suppose a client completed payment for a particular product from a business entity. Suppose further the client provided feedback in the form of a customer review. In this example scenario, the ML engine can weight the review feedback with a higher weight than a weight that is provided to the payment interaction. In this scenario, the ML engine determined the feedback more accurately reflects the relationship between the client and the business, so the ML engine assigned a higher level of importance to that interaction. The disclosed ML engine is able to dynamically learn and adapt over time to determine which interaction types are to be prioritized and weighted over other interaction types.

In some cases, interactions by one user might be weighted differently than interactions by another user. That is, the ML engine can be configured to customize weights for each individual user as opposed to using a brute-force “one size fits all” approach.

The weighting factors can also include a time factor 565. To illustrate, in some cases, interactions that have occurred more recently can be weighted more heavily over interactions that occurred earlier. As an example, an interaction that occurred today can be weighted more heavily than an interaction that occurred one year ago.

In some implementations, the time factor 565 can include a weighted average that operates to penalize a score that occurred in the past using a defined time-decay algorithm. More recent interactions are more relevant and reflect more heavily on the client-entity relationship than ones in the past.

There are different ways or algorithms for aggregating data with time decays, one of which is shown below:

t₀=1

tᵢ=(1−α)ⁱfori>0

Here, alpha is the decay constant. The inputs can be sorted based on their timestamps or creation times, so the most recently received time-based weight factor is t₀, the second is t₁, etc. The time-based weight factor t₁ thus penalizes each input's score by its position over time.

This reduces the influence of each input on the client's experience score based on how long ago the input or interaction occurred. Recent interactions receive more weight. Other time approaches can be used, such as simple linear decays, or weights based on calendar time rather than uniform sorted order.

Accordingly, in some implementations, each of the weighting factors can include a corresponding timing aspect. With this timing aspect, sentiment data that is relatively older is weighted less than sentiment data that is relatively newer.

As another example of a time-based weighting factor scenario, a survey can be considered as being more important than an online chat, so the embodiments can assign a heavier weight wᵢ to that input. the timing factor, however, can result in the online chat being weighted more heavily. To illustrate, suppose the survey was completed six months ago, but the online chat just recently happened. These inputs can be weighted based on their importance levels as well as based on the timing. Although the survey might be considered more important, the resulting final scores for each interaction may result in the online chat being weighted more heavily because of its timing aspect. Thus, the weighted averages can be configured to penalize scores that occurred in the past with a time decay.

More recent interactions are more relevant than ones in the past. For instance, if a customer complained last year but then referred a friend last week, that indicates the customer overcame the complaint or the company resolved the issue, and the customer is now happy again. Further details on the timing aspect will be provided later.

By way of additional clarification, in some scenarios, the weighting factors can include a first weighting factor and a second weighting factor. The first weighting factor can optionally correspond to a survey response type of interaction the client had with the entity, and the second weighting factor can optionally correspond to a webchat type of interaction. In this scenario, the first weighting factor can be greater than the second weighting factor because the survey may be considered more relevant than the webchat. Additional factors, however, can be applied, such as the timing factor. The combination of the different factors will result in the generation of a particular score for a particular type of interaction.

Returning to FIG. 4, the ML engine 405 aggregates the normalized and weighted scores to generate an aggregate score 440, which is then provided as output 445 in the form of an experience score. One example approach to aggregating the scores is to perform a doubly weighted average over all of the normalized scores. The equation provided below is an example of such an approach.

$$score = \frac{{Σ}_{i}^{M} {w}_{i} * {t}_{i} * {s}_{i}}{{Σ}_{i}^{M} {w}_{i} * {t}_{i}}$$

In the above algorithm, M is the number of inputs for this particular customer, wᵢ is the importance weight for the ith input, tᵢ is the history weight for the ith input based on the time of feedback or interaction, and sᵢ is the normalized score from that input. FIG. 5 shows an aggregated score 570, which is representative of the aggregate score 440.

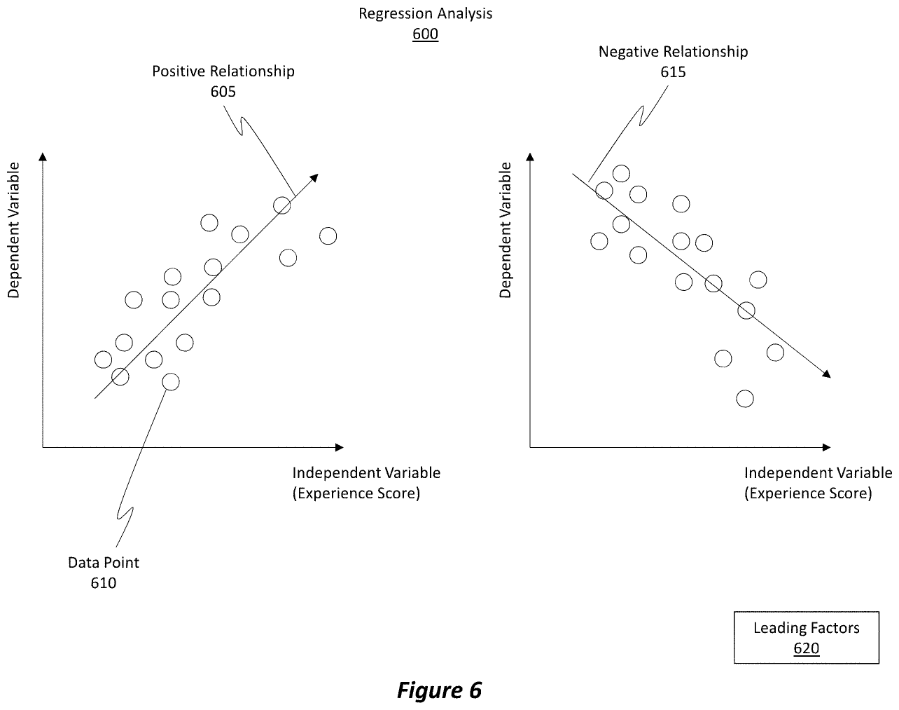

In some embodiments, the ML engine 405 can also perform a regression analysis 450. The regression analysis 450 generally refers to a technique for identifying trends in data, such as possible dependencies between variables. As will be discussed in more detail shortly, the ML engine 405 can perform the regression analysis 450 in an effort to identify which specific interaction types or which specific events contributed most heavily to a user's particular experience score. By identifying these most impactful events or interactions, the disclosed embodiments can then modify subsequent interactions in order to re-use positive interactions/events or to prevent the use of negative interactions/events for a particular client. FIG. 6 is illustrative.

FIG. 6 shows an example regression analysis 600 that can be performed by the ML engine mentioned earlier. FIG. 6 specifically shows two scenarios. One scenario shows a generally positive relationship 605, where a number of data points (e.g., data point 610) represent the positive trend in the relationship. The data point 610 is an example of the sentiment data that the ML engine is using. A second scenario shows a generally negative relationship 615 based on other data.

The embodiments are able to identify specific interactions or specific types of sentiment data that led to the relationship being the way it is, or rather, that perhaps contributed the most in how the relationship is currently viewed by the client. The high contributing data is reflected in FIG. 6 as the leading factors 620. An example will be helpful.

Suppose a client initially perceived the entity in a generally negative manner. Further suppose a customer representative reached out to the client and provided targeted promo codes for a particular product the client likes. Later, the client might leave feedback expressing great pleasure with the entity as a result of that particular interaction. The interaction where the representative contacted the client and provided the promo codes may result in the client now having a generally positive viewpoint of the entity, and the experience score can be updated accordingly. The ML engine can analyze the data and determine that this one interaction was a leading factor that significantly altered or impacted the client's experience score.

Both positive and negative leading factors 620 can be identified as a result of performing the regression analysis 600. As will be discussed in more detail shortly, a subsequent behavior of the system can then be modified based on the detection of these leading factors 620 as well as based on the user's experience score. Accordingly, in some embodiments, a machine learning engine performs regression analysis on the sentiment data in an attempt to identify which one or more leading factors (e.g., the interactions or the events that triggered the generation of the sentiment data) had a largest impact on the relationship between the client and the entity.

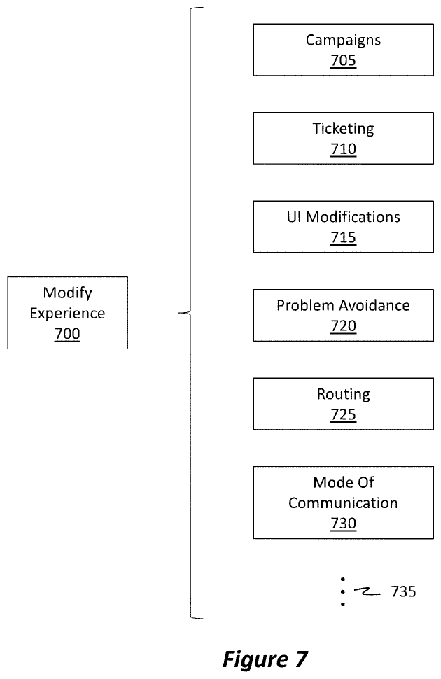

Returning to FIG. 1, the architecture 100 then shows how the system can modify the user's subsequent experiences or interactions based on the aggregated score 170, as shown by modify experience 175. The embodiments can continually or at least periodically monitor sources and interactions and can continually or at least periodically update the user's aggregated score 170 in an effort to improve that score. The system can also continually or periodically modify a user's subsequent interactions with the system in an attempt to improve those interactions. These continual or periodic operations are reflected in the architecture 100 by the feedback loop 180. That is, the disclosed embodiments are able to continuously learn over time based on the user's interactions, and the embodiments are able to make micro or macro modifications to those interactions in order to improve the user's interactions over time. FIG. 7 lists some examples by which the embodiments are able to modify subsequent interactions the user might have with the system or with an entity.

FIG. 7 shows various examples of how the disclosed embodiments can modify a user's experience with an entity, as represented by modify experience 700. In one scenario, various campaigns 705 can be triggered. A campaign can include targeted promotions or advertisements that are directed to a client. In another scenario, various ticketing 710 can be triggered. A ticket can be a business-side tracking mechanism to indicate when the last time a client representative of the business reached out to the client.

In some cases, the embodiments can modify the visual display of information that is provided to a client, as reflected by user interface (UI) modifications 715. Any number of different modifications can be made to a UI. Such modifications can include adjusting the size of text or images that are displayed, adjusting the type of data that is displayed (e.g., more or less text, audio, or videos), or providing or preventing certain data from being displayed to a client. Another modification can include reducing the number of actions a client might have to perform in order to navigate to a particular product on a business's website. For instance, the embodiments can track and monitor what products a client particularly likes and purchases frequently. The embodiments can modify a UI so that the product is immediately displayed when a client first navigates to a business's website, thereby reducing the number of navigations the client has to take to reach the desired product. Such modifications can greatly improve the client's perception of the entity.

Another modification can include preventing certain information from being displayed to a client. For instance, it may be the case that certain content is off-putting or perhaps offensive to a particular client. In response to learning this information, the embodiments can optionally modify the UI to prevent that information as well as similar information from being displayed for that client.

The embodiments can also perform problem avoidance 720. That is, based on past interactions, the embodiments can identify which specific interactions led to a negative experience for the client. By learning from such negative interactions, the embodiments can avoid those types of interactions as well as similar interactions in the future. Instead, alternative forms of interactions can be pursued and advanced when the client interacts with the entity.

The system can also modify a client's experience by using different routing 725 techniques. In some cases, routing 725 can refer to a scenario where a client is provided with elevated handling by a client representative or perhaps can refer to a scenario where a client is linked or routed to a specific client representative. As an example, the ML engine can optionally learn a personality type or psychological type of a client based on past interactions the client has had. Based on the determined personality type, the embodiments can link the client with a client representative who has a similar personality type or who is trained to handle the client's specific personality type. In this manner, the selected client representative can better connect with the client and can better serve the client's needs. Accordingly, routing 725 can refer to a scenario where a specially selected representative is selected and tasked with handling a particular client in order to either rehabilitate the relationship or perhaps to improve it even further.

Another way to modify the client's subsequent interactions with the entity is by modifying and controlling the mode of communication 730 the client later has with the entity. Based on past interactions and/or experience scores, the system may determine that the client prefers text-based communications as opposed to calls. The system can then set as a default the use of text for all subsequent communications with that particular client. Accordingly, the mode by which a client communicates with an entity can be modified based on the learned information. The ellipsis 735 illustrates how other modifications or adjustments can be performed based on a client's experience score.

### Example User Interfaces

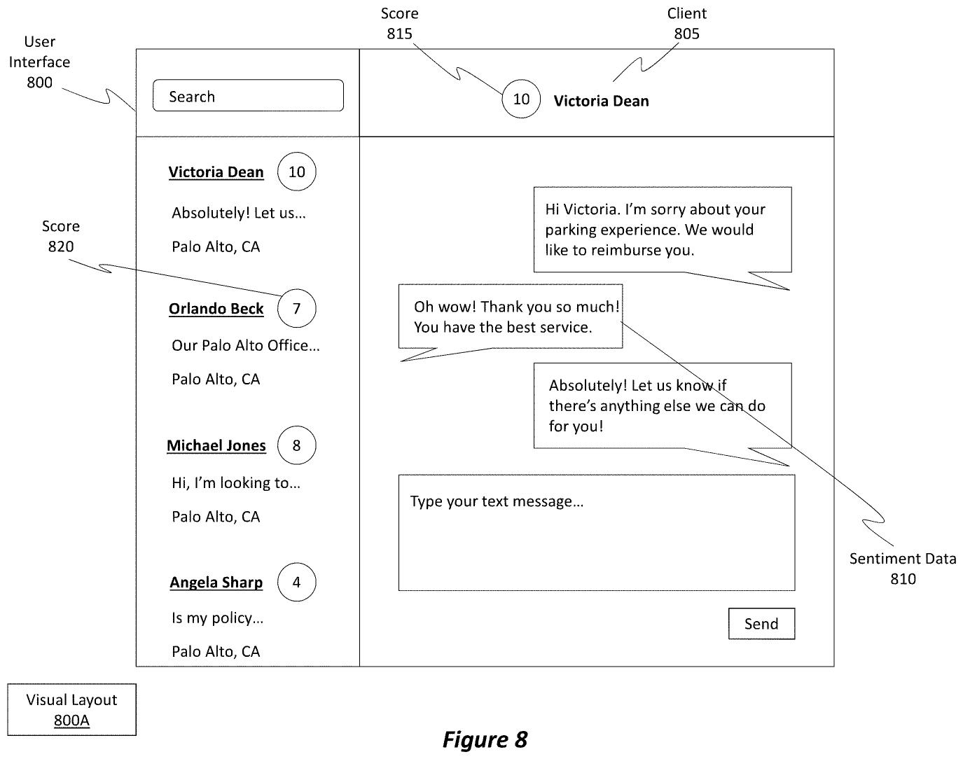

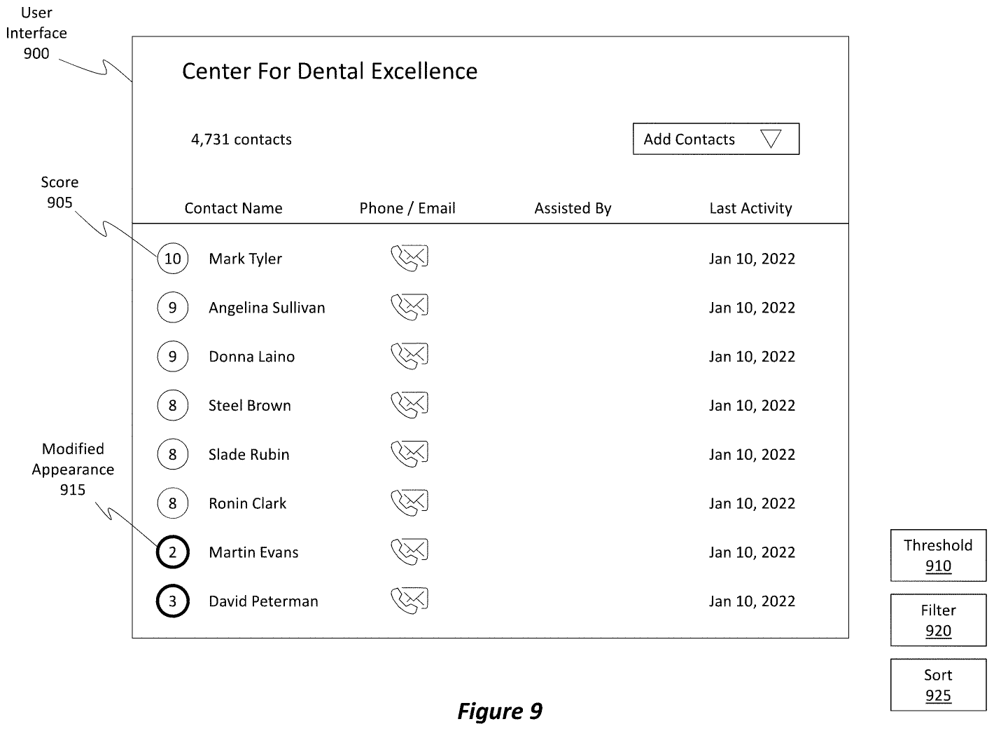

FIGS. 8 and 9 present some examples of various user interfaces that are configured to display a client's experience score. Stated differently, some user interfaces can be configured to have a specific visual layout designed to enable the intuitive display of a user's experience score.

FIG. 8 shows an example user interface 800 that has a particular visual layout 800A. Specifically, the visual layout 800A includes a display about a client 805, such as the client's name (e.g., “Victoria Dean”). This particular user interface 800 is a chat module where clients can chat with representatives from a business entity.

The user interface 800 can be included as a part of the described “platforms,” which can be implemented as or within the architecture 100 of FIG. 1. The platform allows businesses or entities to sort their customers by experience score to see the most happy and unhappy. The platform also allows businesses to drive campaigns and customer interactions based on customer scores, such as asking all 8-10 score customers to refer a friend, or sending contact emails to 0-4 customers to try to improve relations.

In the scenario shown in FIG. 8, the client 805 has provided sentiment data 810. The disclosed embodiments are able to acquire this sentiment data 810 and use it to generate and/or update a client's score 815. That score 815 is then displayed at a location proximate to the client's name in the user interface 800. The score can also be displayed at other areas within the user interface 800. For instance, in a sidebar client chat listing (e.g., on the left hand side of the user interface 800), a listing of various clients and a brief snapshot of their chat conversations is displayed. Each client's computed score can also be displayed proximately to each respective client's name. For instance, the score 820 is displayed next to the client named “Orlando Beck.”

FIG. 9 shows another example user interface 900 where experience scores are displayed next to a corresponding client, such as the score 905 being displayed next to the client named “Mark Tyler.” In accordance with some implementations, a threshold 910 can be defined. Scores that are below this threshold 910 can have their visual appearance modified in the user interface 900 in order to call greater attention to those scores. As an example, suppose the threshold 910 is set to a score value of “3.” Any scores that are 3 or below will have their visual appearances modified.

In FIG. 9, one can observe how “Martin Evans” and “David Peterman” both had their scores modified in visual appearance, as shown by the modified appearance 915. In this example scenario, the circle surrounding the numeric value has been displayed in a bold manner. Of course, other techniques can be used to emphasize a score's visual appearance. Such techniques include one or more of a flashing appearance, a color change, a size change, and so on, without limit.

The user interface 900 can be further configured to provide a filter 920 option and/or a sort 925 option based on the client's experience scores. For instance, a user can filter the displayed scores based on any number of defined criteria, such as perhaps scores that are below a threshold or perhaps scores that are “stale” because they have not been updated recently (e.g., they have not been updated within a defined time period). Of course, other criteria can be used to filter and display scores. The embodiments can also sort the scores, such as from highest to lowest or from lowest to highest or even from most recently updated to least recently updated, or vice versa. Using the filtering and sorting options enables a business representative to target or identify specific clients for campaign purposes in order to rehabilitate a relationship or to further improve the relationship.

Accordingly, the embodiments can be configured to display a client interface that has a particular visual layout. The particular visual layout includes displaying the experience score at a location that is proximate to a name of the client. In some cases, the client interface is configured to rank clients based on their corresponding experience scores. Optionally, a threshold score can be defined, and targeted notices can be transmitted to clients whose experience scores are below or above the threshold score.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

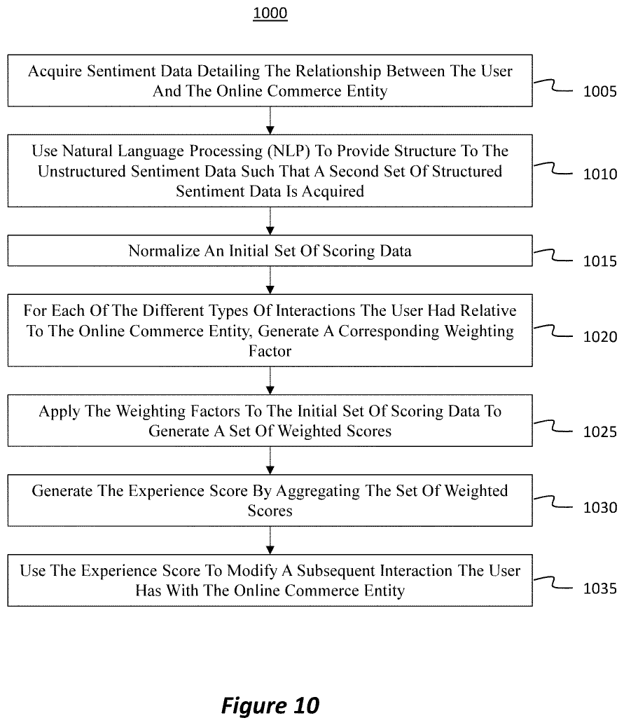

Attention will now be directed to FIG. 10, which illustrates a flowchart of an example method 1000 that can be performed using the architecture 100 of FIG. 1. In some implementations, the method 1000 can be implemented by the ML engine 140A and by the interactions engine 140 of FIG. 1. By following the method 1000, the embodiments will be configured to generate and dynamically update an experience score for a client, where the experience score operates as a quantitative indicator describing a relationship between the client and an entity, such as perhaps an online entity (e.g., a cloud entity or an online business entity or perhaps a brick and mortar business). The embodiments will be further configured to use the experience score to modify one or more subsequent interactions the client has with the entity so as to improve the relationship.

Initially, method 1000 includes an act (act 1005) of acquiring (e.g., perhaps by the interactions engine 140 of FIG. 1) sentiment data detailing the relationship between the client and the entity. The sentiment data is acquired from different types of interactions the client had relative to the entity. Furthermore, the sentiment data includes structured sentiment data and unstructured sentiment data.

As examples only, the different types of interactions can include one or more of the following: an interaction where the client exchanged chat messages with the entity; an interaction where the client completed a survey; an interaction where the client posted a review about the entity on a public network; an interaction where the client posted information about the entity on a social media account; an interaction where the client completed a payment; an interaction where the client referred the entity to another client; or an interaction in which the client received a message from the entity and ignored the message. Other examples of interactions can include an interaction where the client exchanged an email with the entity; an interaction where the client called the entity and/or left a voicemail; or an interaction where the client visited a website of the entity.

Optionally, the unstructured sentiment data can include one or more of the following: a type-written client review about the entity; a type-written client comment, where the type-written client comment is included in one or more of a chat message, a text message, or a social media message; or a voice message; or a video; or a type-written client comment in a survey sent by the entity.

On the other hand, the structured sentiment data can include a quantified rating of the entity by the client. An example of a quantified rating can involve the client leaving a certain number of stars as a rating for the entity, where the stars represent one form of a “quantified rating.”

Act 1010 includes using natural language processing (NLP) to provide structure to the unstructured sentiment data. As a consequence, a second set of structured sentiment data (e.g., the set of structured sentiment data 415A from FIG. 4) is acquired. The structured sentiment data and the second set of structured sentiment data constitute an initial set of scoring data (e.g., initial set of scoring data 415B in FIG. 4). Notably, the structures for all the data included in the initial set of scoring data is set to match one another. As an example, the structures may all now be numeric values. As another example, the structures could be a letter-grade value. Indeed, any structure can be used.

Act 1015 includes normalizing the initial set of scoring data. Normalizing the scoring data results in all the scoring data having or following the same scale.

For each of the different types of interactions the client had relative to the entity, act 1020 includes generating a corresponding weighting factor. Notably, each weighting factor assigns a relative importance level to each respective type of interaction.

After normalizing the initial set of scoring data, act 1025 includes applying the weighting factors to the initial set of scoring data to generate a set of weighted scores (e.g., set of weighted scores 435A from FIG. 4).

In some implementations, the process of applying the weighting factors includes applying a first weighting factor to a first portion of the initial set of scoring data. Here, the first portion is associated with a first type of interaction the client had relative to the entity. With reference to FIG. 5, the “first portion” can be the data associated with the messages 505 type of interaction. The weight 560 was generated for these interactions and was applied to the normalized score 555.

To continue, the process of applying the weighting factors can further include applying a second weighting factor to a second portion of the initial set of scoring data. Here, the second portion is associated with a second type of interaction the client had relative to the entity. Again with reference to FIG. 5, the “second portion” can be the data associated with the webchat 510 type of interaction. A corresponding weight was generated for these interactions and was applied to that corresponding normalized score (e.g., the score having the value “9”).

Optionally, a time factor can be included as a part of each weighting factor. The execution of the time factor causes relatively older sentiment data to be weighted less than relatively newer sentiment data. In some cases, the time factor can include one or more of a non-linear time decay algorithm, a linear decay algorithm, or an algorithm based on calendar time.

After generating the set of weighted scores, act 1030 includes generating the experience score by aggregating the set of weighted scores. For instance, the aggregate score 440 in FIG. 4 is representative of the experience score.

Act 1035 then includes using the experience score to modify a subsequent interaction the client has with the entity. For instance, modify experience 175 from FIG. 1 and modify experience 700 from FIG. 7 are representative of example options for modifying the user's subsequent interactions with the entity. As a few examples, the process of modifying the subsequent interaction the client has with the entity can optionally include one or more of the following: preventing certain data from being presented to the client; routing the client to a particular website; modifying a client interface; or modifying a mode of communication that is used to communicate with the client. Another way to dynamically influence interactions is by initiating a new interactions, such as by prompting a client to refer another client.

Beneficially, an interactions engine can be configured to at least periodically monitor for new sentiment data. As a further benefit, the client's experience score can be updated based on the new sentiment data that is acquired.

In some cases, an analysis of the score's trend over time can be conducted to identify score peaks, valleys, derivatives, and so forth. Radical changes over time (e.g., where the derivative of the score's trend changes more than a threshold amount) can be subjected to extra scrutiny to identify which events caused such a radical change. An ML engine can be tasked with analyzing the score's trend and can be configured to make future predictions based on past behavior. Using those predictions, the ML engine can be tasked with modifying the user's future interactions (e.g., by preventing the display of information, by displaying certain information, by reducing the number of user operations that are needed to reach a destination page, etc.) in an effort to increase the score's value over time.

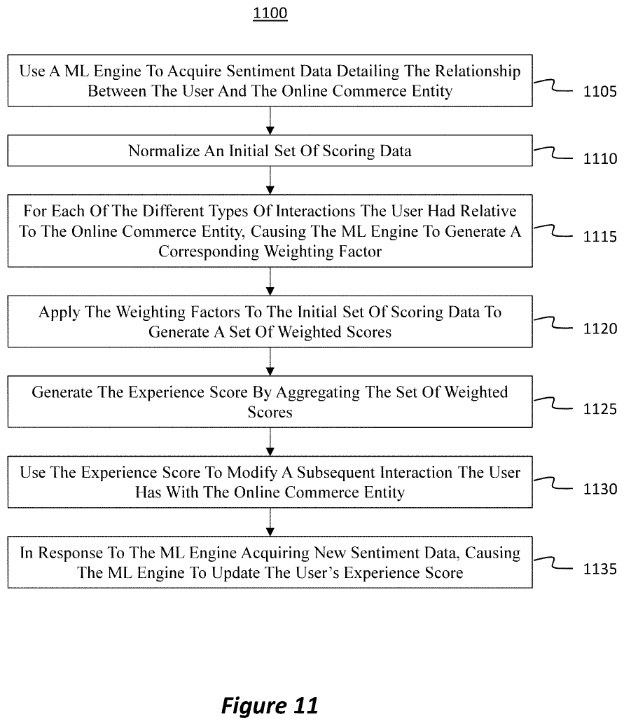

FIG. 11 shows another example method 1100, which is somewhat similar to method 1000 of FIG. 10 and which can also be implemented in the architecture 100 of FIG. 1.

Method 1100 includes an act (act 1105) of using an interactions engine to acquire sentiment data detailing the relationship between the client and the entity. The interactions engine acquires the sentiment data from different types of interactions the client had relative to the entity. In some cases, the interactions engine acquires at least some of the sentiment data from one or more third party sources by crawling a public network. The sentiment data is structured (e.g., by the NLP/the ML engine) to generate an initial set of scoring data.

Act 1110 includes normalizing the initial set of scoring data. For each of the different types of interactions the client had relative to the entity, act 1115 includes causing an ML engine to generate a corresponding weighting factor. Each weighting factor assigns a relative importance level to each respective type of interaction.

After normalizing the initial set of scoring data, act 1120 includes applying the weighting factors to the initial set of scoring data to generate a set of weighted scores. After generating the set of weighted scores, act 1125 includes generating the experience score by aggregating the set of weighted scores.

Act 1130 includes using the experience score to modify a subsequent interaction the client has with the entity. In response to the interactions engine acquiring new sentiment data, act 1135 includes causing the ML engine to update the client's experience score.

Accordingly, the disclosed embodiments are beneficially able to generate and dynamically update an experience score for a client, where the experience score operates as a quantitative indicator describing a relationship between the client and an entity. The embodiments can further use the experience score to modify one or more subsequent interactions the client has with the entity so as to improve the relationship.

The disclosed systems are beneficially able to generate an experience score that represents a customer's current, real-time feelings toward an entity (e.g., perhaps a business) and that entity's offerings. The experience score can be based on a normalization of customer experiences, including experiences that are not associated with ratings or have discernable sentiments. The customer experiences can be derived from feedback and monitored interactions with the entity. The embodiments can analyze direct interactions such as online reviews or surveys in combination with indirect interactions (e.g., interactions not specifically intended by an entity to capture client feelings or sentiments) such as “refer a friend” or chat “conversations” to create a real time experience score for a specific entity. Entities can use the experience score to more effectively target clients and to provide the best products and services available in real time.

### Example Computer/Computer systems

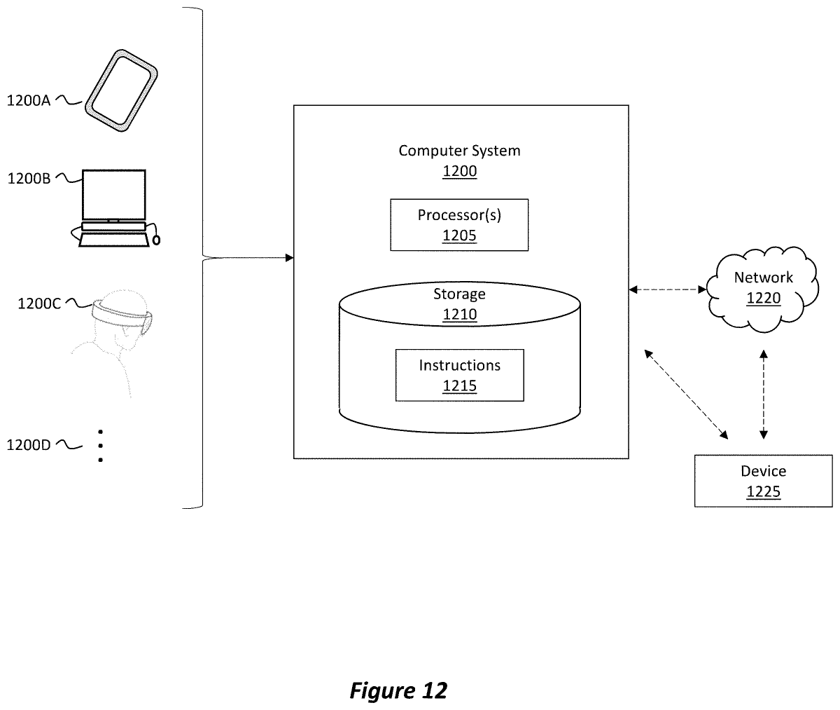

Attention will now be directed to FIG. 12 which illustrates an example computer system 1200 that may include and/or be used to perform any of the operations described herein, such as by performing the acts listed in methods 1000 and 1100 of FIGS. 10 and 11, respectively. Computer system 1200 may take various different forms. For example, computer system 1200 may be embodied as a tablet 1200A, a desktop or a laptop 1200B, a wearable device 1200C, a mobile device, or any other standalone device, as represented by the ellipsis 1200D. Computer system 1200 may also be a distributed system that includes one or more connected computing components/devices that are in communication with computer system 1200.

In its most basic configuration, computer system 1200 includes various different components. FIG. 12 shows that computer system 1200 includes one or more processor(s) 1205 (aka a “hardware processing unit”) and storage 1210.

Regarding the processor(s) 1205, it will be appreciated that the functionality described herein can be performed, at least in part, by one or more hardware logic components (e.g., the processor(s) 1205). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” or “engine” can refer to hardware processing units or to software objects, routines, or methods that may be executed on computer system 1200. The different components, modules, engines, and services described herein may be implemented as objects or processors that execute on computer system 1200 (e.g. as separate threads). The disclosed ML engine (or perhaps even just the processor(s) 1205) can be configured to perform any of the disclosed method acts or other functionalities.

Storage 1210 may be physical system memory, which may be volatile, non-volatile, or some combination of the two. The term “memory” may also be used herein to refer to non-volatile mass storage such as physical storage media. If computer system 1200 is distributed, the processing, memory, and/or storage capability may be distributed as well.

Storage 1210 is shown as including executable instructions 1215. The executable instructions 1215 represent instructions that are executable by the processor(s) 1205 (or perhaps even the ML engine) of computer system 1200 to perform the disclosed operations, such as those described in the various methods.

The disclosed embodiments may comprise or utilize a special-purpose or general-purpose computer including computer hardware, such as, for example, one or more processors (such as processor(s) 1205) and system memory (such as storage 1210), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RANI, ROM, EEPROM, CD-ROM, solid state drives (“SSD”) that are based on RANI, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1200 may also be connected (via a wired or wireless connection) to external sensors (e.g., one or more remote cameras) or devices via a network 1220. For example, computer system 1200 can communicate with any number devices (e.g., device 1225) or cloud services to obtain or process data (e.g., sentiment data). In some cases, network 1220 may itself be a cloud network. Furthermore, computer system 1200 may also be connected through one or more wired or wireless networks to remote/separate computer systems(s) that are configured to perform any of the processing described with regard to computer system 1200.

A “network,” like network 1220, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1200 will include one or more communication channels that are used to communicate with the network 1220. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RANI and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system configured to generate and dynamically update an experience score for a client, where the experience score operates as a quantitative indicator describing a relationship between the client and an entity, the computer system being further configured to use the experience score to modify one or more subsequent interactions the entity has with the client so as to improve the relationship, said computer system comprising:
one or more processors; and
one or more computer-readable hardware storage devices that store instructions that are executable by the one or more processors to cause the computer system to:
acquire sentiment data detailing the relationship between the client and the entity, wherein the sentiment data is acquired from different types of interactions the client had relative to the entity, and wherein the sentiment data includes structured sentiment data and unstructured sentiment data;
use natural language processing (NLP) to provide structure to the unstructured sentiment data such that a second set of structured sentiment data is acquired, wherein the structured sentiment data and the second set of structured sentiment data constitute an initial set of scoring data;
normalize the initial set of scoring data;
for each of the different types of interactions the client had relative to the entity, generate a corresponding weighting factor, wherein each weighting factor assigns a relative importance level to each respective type of interaction;
after normalizing the initial set of scoring data, apply the weighting factors to the initial set of scoring data to generate a set of weighted scores;
after generating the set of weighted scores, generate the experience score by aggregating the set of weighted scores; and
use the experience score to modify a subsequent interaction the client has with the entity.

2. The computer system of claim 1, wherein structures for all data included in the initial set of scoring data are set to match one another.

3. The computer system of claim 1, wherein applying the weighting factors includes applying a first weighting factor included in said weighting factors to a first portion of the initial set of scoring data, the first portion being associated with a first type of interaction the client had relative to the entity, and
wherein applying the weighting factors further includes applying a second weighting factor included in said weighting factors to a second portion of the initial set of scoring data, the second portion being associated with a second type of interaction the client had relative to the entity.

4. The computer system of claim 1, wherein the different types of interactions include one or more of the following:
an interaction where the client exchanged chat messages with the entity;
an interaction where the client exchanged an email with the entity;
an interaction where the client called the entity and/or left a voicemail;
an interaction where the client completed a survey;
an interaction where the client posted a review about the entity on a public network;
an interaction where the client posted information about the entity on a social media account;
an interaction where the client completed a payment;
an interaction where the client referred the entity to another client;
an interaction in which the client received a message from the entity and ignored the message; or
an interaction where the client visited a website of the entity.

5. The computer system of claim 1, wherein the unstructured sentiment data includes one or more of the following:
a type-written client review about the entity;
a type-written client comment, wherein the type-written client comment is included in one or more of a chat message, a text message, or a social media message;
a voice message; or
a type-written client comment in a survey sent by the entity.

6. The computer system of claim 1, wherein the structured sentiment data includes a quantified rating of the entity by the client.

7. The computer system of claim 1, wherein each of the weighting factors includes a corresponding timing aspect, and wherein sentiment data that is relatively older is weighted less than sentiment data that is relatively newer.

8. The computer system of claim 1, wherein the weighting factors include a first weighting factor and a second weighting factor, the first weighting factor corresponds to a survey response type of interaction the client had with the entity, and the second weighting factor corresponds to a webchat type of interaction, and
wherein the first weighting factor is greater than the second weighting factor.

9. The computer system of claim 1, wherein modifying the subsequent interaction the client has with the entity includes one or more of the following:
preventing certain data from being presented to the client;
routing the client to a particular website;
modifying a client interface;
modifying a mode of communication that is used to communicate with the client; or
sending a referral request.

10. The computer system of claim 1, wherein a machine learning engine performs regression analysis on the initial set of scoring data in an attempt to identify which one or more leading factors had a largest impact on the relationship between the client and the entity.

11. A method for generating and dynamically updating an experience score for a client, where the experience score operates as a quantitative indicator describing a relationship between the client and an entity, the method further using the experience score to modify one or more subsequent interactions the client has with the entity so as to improve the relationship, said method comprising:
acquiring sentiment data detailing the relationship between the client and the entity, wherein the sentiment data is acquired from different types of interactions the client had relative to the entity, and wherein the sentiment data includes structured sentiment data and unstructured sentiment data;
using natural language processing (NLP) to provide structure to the unstructured sentiment data such that a second set of structured sentiment data is acquired, wherein the structured sentiment data and the second set of structured sentiment data constitute an initial set of scoring data;
normalizing the initial set of scoring data;
for each of the different types of interactions the client had relative to the entity, generating a corresponding weighting factor, wherein each weighting factor assigns a relative importance level to each respective type of interaction;
after normalizing the initial set of scoring data, applying the weighting factors to the initial set of scoring data to generate a set of weighted scores;
after generating the set of weighted scores, generating the experience score by aggregating the set of weighted scores; and
using the experience score to modify a subsequent interaction the client has with the entity.

12. The method of claim 11, wherein a public network is crawled to acquire at least some of the sentiment data.

13. The method of claim 11, wherein big data mining is performed to acquire at least some of the sentiment data.

14. The method of claim 11, wherein a machine learning engine generates the weighting factors, and wherein the machine learning engine updates the weighting factors over time based on newly learned data.

15. The method of claim 11, wherein the method further includes displaying a client interface that has a particular visual layout, and wherein the particular visual layout includes displaying the experience score at a location that is proximate to a name of the client.

16. The method of claim 15, wherein the client interface is configured to rank clients based on their corresponding experience scores, wherein a threshold score is defined, and wherein targeted notices are transmitted to clients whose experience scores are below or above the threshold score.

17. The method of claim 11, wherein a time factor is included as a part of each weighting factor, and wherein execution of the time factor causes relatively older sentiment data to be weighted less than relatively newer sentiment data, and wherein the time factor includes one or more of a non-linear time decay algorithm, a linear decay algorithm, or an algorithm based on calendar time.

18. The method of claim 11, wherein an interactions engine at least periodically monitors for new sentiment data, and wherein the client's experience score is updated based on the new sentiment data.

19. A method for generating and dynamically updating an experience score for a client, where the experience score operates as a quantitative indicator describing a relationship between the client and an entity, the method further using the experience score to modify one or more subsequent interactions the client has with the entity so as to improve the relationship, said method comprising:
using an interactions engine to acquire sentiment data detailing the relationship between the client and the entity, wherein the interactions engine acquires the sentiment data from different types of interactions the client had relative to the entity, and wherein the sentiment data is structured to generate an initial set of scoring data;
normalizing the initial set of scoring data;
for each of the different types of interactions the client had relative to the entity, causing a machine learning (ML) engine to generate a corresponding weighting factor, wherein each weighting factor assigns a relative importance level to each respective type of interaction;
after normalizing the initial set of scoring data, applying the weighting factors to the initial set of scoring data to generate a set of weighted scores;
after generating the set of weighted scores, generating the experience score by aggregating the set of weighted scores;
using the experience score to modify a subsequent interaction the client has with the entity; and
in response to the interactions engine acquiring new sentiment data, causing the ML engine to update the client's experience score.

20. The method of claim 19, wherein the interactions engine acquires at least some of the sentiment data from one or more third party sources by crawling a public network.
